(19) United States
(12) Patent Application Publication
(10) Pub. No.: US 2001/0051379 A1
(43) Pub. Date: Dec. 13, 2001

(54) Method for detecting drugs, and a solvent and a decomposition solution used therefor

(76) Inventor: Josef Pucher, Vienna (AT)

Correspondence Address: JACOBSON HOLMAN PLLC, 400 SEVENTH STREET N.W., SUITE 600, WASHINGTON, DC, 20004, US

(21) Appl. No.: 09/774,588

(22) Filed: Feb. 1, 2001

Related U.S. Application Data
(63) Continuation of application No. PCT/AT99/00195, filed on Aug. 4, 1999.

(30) Foreign Application Priority Data
Aug. 4, 1998 (AT) A 1347/98
May 19, 1999 (AT) GM 349/99

(51) Int. Cl. G01N 1/28

(52) U.S. Cl. 436/175; 436/174; 422/61; 436/17

(57) ABSTRACT

The invention relates to a method for the quick and direct on-site detection of drugs and drug substitutes which are in solid form. According to the invention, the drugs or drugs substitutes are transferred to a decomposition vessel or reaction vessel without being pretreated, especially without being reduced in size. Afterwards, they are mixed with a solvent or a solvent mixture containing at least one organic solvent. In addition, the suspension and/or solvent containing the drugs or drugs substitutes is/are directly subjected to a known drug test method, especially using drug test strips. The invention also provides a solvent or solvent mixture and a decomposition solution therefor, and a device for carrying out the method.

The present invention is a continuation application of PCT/AT99/00195, filed Aug. 04, 1999.

### BACKGROUND OF THE INVENTION

1. Field of the Invention

The present invention relates to a method for the rapid and direct in situ detection of drugs or drug substitutes in solid forms, a solvent or solvent mixture and a decomposing solution for use in such a method as well as a device for carrying out the method.

2. Description of the Prior Art

In order to clearly detect the presence of drugs or drug substitutes, it has so far been required in most cases to have the same analyzed at high expenses in special chemical laboratories so as to obtain a conclusive result as to whether a substance found, for instance, in the course of routine checks by the police or gendarmerie does actually contain drugs or drug substitutes. This is necessary, in particular, because hitherto only the detection of liquid drugs has been feasible by means of known short tests using drug strips that are commercially available and such detection procedures also are interfered with, in particular, by substances or masking agents which are frequently admixed to drugs or drug substitutes in order to change their taste, on the one hand, and extend the same and, thus, render them safer or hamper detection, on the other hand. The drug test strips used to date for the in situ detection of drugs present in the liquid state or drugs present in the dissolved state, therefore, frequently indicate the presence or absence of drugs without this corresponding to the actual facts so that no conclusive evidence as to the actual presence of drugs or drug substitutes will be obtained, since a substance interfering with the analysis will quite frequently falsify the drug test towards positive or negative results, respectively.

### SUMMARY OF THE INVENTION

The invention, therefore, aims to meet the long-term need for a safe and rapid test or detection method which is able to proof the presence or absence of drugs or drug substitutes in any substances, wherein, in addition, such a detection in a safe and reproducible manner not only is to give evidence as to the presence of drugs or drug substitutes, but also is to enable differentiation as to what kind of drugs or drug substitutes the person analyzing the sample is confronted with, wherein any interference with, or adverse influence by, common substances or masking agents admixed to the drugs is to be avoided.

To solve these objects, a method for the rapid and direct in situ detection of drugs or drug substitutes in solid forms is provided, which is essentially characterized in that the drugs or drug substitutes are transferred into a decomposition or reaction vessel without pretreatment, in particular without disintegration, are supplemented with a solvent or solvent mixture containing at least one organic solvent and the suspension and/or solution containing the drugs or drug substitutes is directly submitted to a drug test procedure known per se, particularly using drug test strips. By dissolving the drugs or drug substitutes without pretreatment, in particular without disintegration, in an organic solvent and/or solvent mixture, they are converted into a state of matter in which, in particular, commercially available drug test strips are applicable and able to yield affirmative results. In this context, it is irrelevant whether the detection or analysis of the substances in question is effected by the aid of drug test strips that respond to a special drug only or such comprising detection strips for a plurality of different drugs or drug groups. Due to the direct convertation into a state of matter in which commonly available drug test strips are operable, security forces, customs officers or even physicians will rapidly and readily have available, without pretreatment, substances considered by them as drugs or drug substitutes in a suspension and/or solution that enables them to effect an analysis quickly, reliably and easily.

In order to ensure proper mixing or dissolving of the drugs or drug substitutes in the solvent or solvent mixture, it is proposed according to a preferred embodiment that the mixture of drugs or drug substitutes and the solvent or solvent mixture is agitated within the decomposition or reaction vessel, in particular for at least 10 to 30 seconds. By such an agitation or shaking of the mixture, it is additionally safeguarded that a uniform suspension and/or solution will be available for an affirmative analysis.

Bearing in mind the fact that some of the commercially available drugs or drug substitutes constitute resin-like substances, in particular natural substances, such as cannabis resin or crude opium, the method according to the invention preferably is developed further to the extent that in the presence of resin-like drugs or drug substitutes the dissolution step is preceded by a step of decomposing the drugs or drug substitutes at ambient temperature in a decomposing solution comprised of a mixture of at least partially polar organic solvents containing, in particular, a solubilizer. Thus, if a substance to be analyzed appears resinous or sticky, the dissolution step according to the invention is preceded by a further step of decomposing the resin-like substance at ambient temperature, whereby the active ingredients, namely e.g. morphines, codeines, ethyl morphin, etc. are dissolved out of the resin-like substance, in particular crude opium or cannabis resin, or the cells of the vegetable samples are broken up or destroyed, merely by adding a special solution to the resin-like substance in order to enable also a layperson without chemical training to dissolve out of the vegetable, resin-like substances the ingredient that constitutes the actual drug and subsequently convert the latter, by dilution with a solvent and/or solvent mixture containing at least one organic solvent, into a form in which a drug test may again be readily and immediately carried out, for instance, by the aid of known test strips.

Since a great number of drugs in solid form either are distributed in tablet form or the like or are carried along with dealers or end consumers in forms intended to mislead security forces as to the presence of drugs or drug substitutes, those substances most frequently are supplemented with socalled extenders or also substances which are known to falsify drug tests even in the laboratory to the effect that the test will appear negative and the sample will be considered as safe. Such extenders or masking agents, for instance, include citric acid, which lowers the pH of the drug or drug substitute in a manner that any commercially available drug test will fail. In order to avoid such a drug test failure, the method according to the invention preferably is further developed to the extent that a solvent or solvent mixture buffered to a pH of 5.5 to 8.5 is used as said solvent or solvent mixture. By using an organic solvent or solvent mixture buffered to a pH of 5.5 to 8.5, it is safeguarded that the method for the detection of drugs will operate in a manner free of difficulties and interferences, since the drug test strips in that substantially “neutral” pH range usually function without problems. Commercially available drug test strips, as a rule, indicate the presence of drugs by a cross bar appearing on the drug test strip. If two cross bars appear on the drug test strip, this will indicate that no drugs are contained in the analyzed sample. Usually, the presence of one or two cross bars, respectively, on the drug test strip, however, is evidence or proof of the presence of drugs or drug substitutes, wherein the person effecting the test procedure will still not be sure on whether the test procedure has actually worked without problem or error. To this end, the method according to the invention is further developed to the extent that an indicator or indicator mixture is added to the solvent or solvent mixture. The addition of an indicator or indicator mixture to the solvent or solvent mixture employed in the method according to the invention causes a change in the color of the indicator outside of the working range of the test strip such that the indicator will indicate the trouble-free functioning of the drug test strip. In doing so, a color change, for instance, from red to green is sought for reasons of simplicity, the presence of the red indicator color indicating an eventual malfunctioning or poor functioning of the method for the rapid and direct in situ detection of solid drugs or drug substitutes, and the presence of a green indicator color indicating the proper functioning of the method according to the invention. The addition of an indicator or indicator mixture, thus, also enables drugs mixed with current additives or masking agents such as, for instance, citric acid to be detected clearly and immediately upon reaction with the solvent or solvent mixture, for instance, by the indicator changing its color.

A further object of the present invention resides in providing a solvent or solvent mixture to be used in an above-mentioned method, which is able to safely and reliably dissolve, and convert into a solution suitable for the application of the detection method, any drugs or drug substitutes as are usually sold or consumed. To solve this object, the solvent or solvent mixture according to the invention for use in a method for the rapid and direct in situ detection of drugs or drug substances in solid form is essentially characterized in that the solvent or solvent mixture containing at least one organic solvent is selected from the group consisting of monovalent alcohols including 1 to 5 carbon atoms, ketones including 3 to 8 carbon atoms, polyvalent alcohols and/or water. Due to the fact that the solvent or solvent mixture containing at least one organic solvent is selected from monovalent lower alcohols, ketones including 3 to 8 carbon atoms, polyvalent alcohols and/or water, the solvent or solvent mixture is polar or weakly polar, thus being able to reliably dissolve nearly all current drugs or drug substitutes usually constituting polar organic macromolecules to such an extent that the sensitive drug tests using drug test strips enable the safe detection of the dissolved sample.

In order to ensure the dissolution of substances having complex molecular structures and, in particular, large molecules with a view to enabling the dissolution of sufficient amounts for the correct detection of those substances can be dissolved in the solvent or solvent mixture according to the invention, a nonionic detergent, in particular (octylphenoxyl)polyethoxyethanol, alcylphenole polyglycolether and/or polyoxyethylene sorbitan monolaurate is added as a solubilizer in an amount of 0.01 to 0.5 wt.-%. Solubilizers will be employed, in particular, if molecules which have complex structures or substances that are hardly or poorly soluble in conventional solvents are to be dissolved rapidly and without requiring elevated amounts of solvent in order to be suppliable to said further reactions or detections. In accordance with the invention, a nonionic detergent in low concentrations is chosen as said solubilizer in order to enable also weakly polar to nearly nonpolar drug or drug substitute molecules to be dissolved in the solvent or solvent mixture according to the invention in sufficient amounts. The use of a nonionic detergent, moreover, ensures a reduction of the surface tension, thus facilitating or enabling uniformly running tests and reproducible values.

In order to exclude falsified values in the detection of drugs by means of the method according to the invention, a buffer preferably is additionally added to the solvent or solvent mixture according to the invention, which buffers the solvent or solvent mixture to a pH that ensures the perfect functioning of the drug test strips to be used subsequently. In a particularly preferred manner, the solvent or solvent mixture is adjusted to a pH of 5.5 to 8.5, in particular 6.5 to 8, by adding buffer solutions, in particular a citrate buffer solution, acetate buffer solution, maleate buffer solution, phosphate buffer solution, triethanolamine-HClEDTA buffer solution, tris buffer solution and glycine buffer solution. It is feasible, in particular by adding a mixture of the buffers mentioned, to buffer the solvent or solvent mixture over an extended pH range, i.e., 5.5 to 8.5, in particular 6.5 to 8, and hence render feasible a reliable and correct analytical result even when analyzing drugs that are strongly extended with, or masked by, for instance citric acid, since even elevated amounts of citric acid present will be reliably buffered by the buffer system available so that these will not at all, or substantially not, be able to interfere with the detection reaction of the drugs or drug substitutes.

In order to proof the correct functioning of the above-described method, the solvent or solvent mixture according to the invention preferably is further developed such that it additionally contains an indicator mixture comprising at least two indicators selected from methyl red sodium salt, bromocresol green, phenolphthalein, 1-naphthole benzein and methylene blue. By adding an indicator mixture comprising at least two indicators, the desired changes in the color of the indicator mixture below and above the working range of the drug test strip is ensured such that a color change to red will occur both above a pH of 8.5 and below a pH of 5.5 and the indicator will show the color green within the desired working range.

In order to provide for a solvent or solvent mixture which is usable, and will work reliably, over an extended period of time, it is proposed according to another preferred embodiment that the solvent or solvent mixture additionally contains a preserving agent.

For a solvent or solvent mixture to be employed for a particularly great number of drugs or drug substitutes, it was found that this preferably contains 2 to 20 wt.-% ethanol, 0.5 to 2 wt.-% acetone, 0.05 to 0.2 mol/l phosphate buffer or tris(hydroxymethyl)aminomethane-HCl buffer solution adjusted to a pH of approximately 7.0, about 0.1 to 0.4 wt.-% polyoxyethylene sorbitan monolaurate und an indicator mixture selected from methyl red sodium salt, bromocresol green, phenolphthalein, 1-naphthole benzein and methylene blue, 0.01 to 0.2 wt.-% of a preserving agent, in particular sodium acide, the balance being water. Such a solvent or solvent mixture stands out not only for being usable with nearly all presently known drugs or drug substitutes, but also for being a solvent or solvent mixture that is stable over a long period of time so as to safeguard the perfect functioning of the solvent even after a long time from filling of the same or nonuse of the solvent.

According to another preferred embodiment of the solvent or solvent mixture according to the invention, it is proposed that a proctective protein, in particular bovine serum albumin, is added to the solvent or solvent mixture. The addition of such a protective protein, in particular bovine serum albumin, helps to improve the running properties in the evaluation, for instance, by the aid of a test strip known per se, whereby, in particular, substantially more sharply defined limits and straight-lined bands will be ensured on such a test strip so that evidence on the presence or absence of drugs or drug substitutes will be reliably given. The addition or use of a protective protein of this kind supports the likewise preferred use of detergents in the sense of enhancing or facilitating evaluation.

In order to be able to safely detect also resin-like drugs or drugs present in resinous forms by the method according to the invention, a decomposing solution according to the invention for use in a method according to the invention is essentially characterized in that the decomposing solution, for at least 80 wt.-%, is comprised of polar organic solvents selected from ketones including 3 to 8 carbon atoms, monovalent alcohols including 1 to 5 carbon atoms, organic acetates such as methyl, ethyl and propyl acetate, as well as a non-ionic detergent, in particular polyoxyethylene sorbitan monolaurate. Such a decomposing solution is able to decompose the resins and, in particular, break up the cells of the usually vegetable drugs so as to release the actual drug components such as 11-nor-Δ⁹-THC or 11-nor-Δ⁸-THC so as to enable the same, after further dilution with the solvent or solvent mixture according to the invention, to be immediately supplied to the method for detecting drugs or drug substitutes without the detection method being interfered with by the resins, which, as a rule, cannot be effectively dissolved. Such a decomposing solution according to the invention may, for instance, contain 2 to 8 wt.-% methyl ethyl ketone, 2 to 8 wt.-% n-butanol, 2 to 8 wt.-% ethyl acetate, 70 to 90 wt.-% acetone as well as 0.01 to 0.5 wt.-% non-ionic detergent, as in correspondence with a preferred embodiment of the invention.

Since the method according to the invention for the rapid and direct in situ detection of solid drugs or drug substitutes usually is supposed to be carried out not by chemists but, for instance, by security forces, border guards or, in the event of accidents, also by physicians, the present invention, furthermore, aims to provide a device for the simple, quick and safe realization of the method according to the invention even by laypersons on the chemical sector. To this end, the device according to the invention, in particular, is devised such that it comprises, in addition to commercially available drug test strips for the detecton of various drugs or drug substitutes, at least one container containing the solvent or solvent mixture defined above as well as at least one container containing the decomposing solution described above. In order to further simplify the realization of the method also for laypersons, the device according to the invention may include further auxiliary means such as spatulae, pincers, special containments for dissolving the substances, a stop-watch, detection cards for drugs and the like. By the aid of the device according to the invention and the optionally included accessory elements, it has thus become readily feasible even to an untrained chemist to rapidly, safely and reliably analyze almost any solid substance for the presence of drugs or drug substitutes.

### DESCRIPTION OF PREFERRED EMBODIMENTS OF THE INVENTION

In the following, the invention will be explained in more detail by way of an exemplary embodiment.

In order to verify whether the method according to the invention and the solvent mixtures used in this method are suitable for the detection of different drugs with or without masking agents, a synthetic drug cocktail consisting of benzodiazepines, barbiturate and certain tricyclic anti-depressants was mixed, with 100 wt.-% citric acid having been additionally added to the mixture as a masking substance. The drug cocktail was present in the solid form, benzodiazepine as well as the tricyclic antidepressants having been present in tablet form and merely the barbiturate having been admixed to the drug cocktail in powder form.

A drug cocktail comprised of one tablet each of benzodiazepine, 0.05 g barbiturate and one tablet of a tricyclic antidepressant was supplemented with 20 ml of an extraction solution comprising a solvent mixture of a tris buffer, tris(hydroxymethyl) aminomethane-HCl, 2 wt.-% ethanol, 0.2 wt.-% polyoxyethylene sorbitan monolaureate, 0.05 wt.-% sodium azide, the balance being water. In addition, the solvent mixture contained a mixture of current indicators including methyl red sodium salt, bromocresol green and phenolphthalein. The solution had a pH of 7.40.

In respect to the drug cocktail supplemented with 100 wt.-% citric acid, the color change of methyl red sodium salt was clearly apparent, hence it was clear that in that case it was attempted to add a masking substance to the drugs, and the subsequent detection on an indicator card might be disturbed by those substances. In respect to the cocktail solely consisting of drugs, no change in the color of the indicator mixture was to be observed.

The mixture of tablets and barbiturate powder and citric acid, respectively, was each filled into a closeable reaction or decomposition vessel without pretreatment and agitated for about 20 seconds. Immediately upon agitation, a common drug test was carried out with a multiple test card, wherein in both cases, i.e., in the case of the pure drug cocktail and in the case of the drug cocktail supplemented with citric acid, both barbiturate and benzodiazepine as well as the tricyclic antidepressant could be clearly detected on the drug test detection card.

Due to the fact that sorbitan monolaureate had been added to the solvent mixture as a detergent, sharply defined lines and uniform horizons of the running surface of the liquid were obtained such that even doubts as to whether further drug components were contained in the cocktail besides those detected could be clearly excluded.

1. A method for the rapid and direct in situ detection of drugs or drug substitutes in solid forms, wherein the drugs or drug substitutes are transferred into a decomposition or reaction vessel without pretreatment, in particular without disintegration, are supplemented with a solvent buffered to a pH of 5.5 to 8.5 or solvent mixture buffered to a pH of 5.5 to 8.5 and containing at least one organic solvent, wherein an indicator or indicator mixture is added to the solvent or solvent mixture, wherein the mixture of drugs or drug substitutes and the solvent or solvent mixture is agitated within the decomposition or reaction vessel, in particular for at least 10 to 30 seconds and wherein the suspension and/or solution containing the drugs or drug substitutes is directly submitted to a drug test procedure known per se, particularly using drug test strips.

2. A method according to claim 1, wherein in the presence of resin-like drugs or drug substitutes the dissolution step is preceded by a step of decomposing the drugs or drug substitutes at ambient temperature in a decomposing solution comprised of a mixture of at least partially polar organic solvents containing, in particular, a solubilizer.

3. A solvent or solvent mixture for use in a method according to claim 1, wherein the solvent or solvent mixture containing at least one organic solvent is selected from the group consisting of monovalent alcohols including 1 to 5 carbon atoms, ketones including 3 to 8 carbon atoms, polyvalent alcohols and/or water, that it is adjusted to a pH of 5.5 to 8.5, in particular 6.5 to 8, by adding buffer solutions, in particular a citrate buffer solution, acetate buffer solution, maleate buffer solution, phosphate buffer solution, triethanolamine-HCl-EDTA buffer solution, tris buffer solution and glycine buffer solution and that it additionally contains an indicator mixture comprising at least two indicators selected from methyl red sodium salt, bromocresol green, phenolphthalein, 1-naphthole benzein and methylene blue.

4. A solvent or solvent mixture according to claim 3, wherein a nonionic detergent, in particular (octylphenoxyl)polyethoxyethanol, alcylphenole polyglycolether and/or polyoxyethylene sorbitan monolaurate is added as a solubilizer in an amount of 0.01 to 0.5 wt.-%.

5. A solvent or solvent mixture according to claim 3, wherein the solvent or solvent mixture additionally contains a preserving agent.

6. A solvent or solvent mixture according to claim 3, containing 2 to 20 wt.-% ethanol, 0.5 to 2 wt.-% acetone, 0.05 to 0.2 mol/l phosphate buffer or tris(hydroxymethyl)aminomethane-HCl buffer solution adjusted to a pH of approximately 7.0, about 0.1 to 0.4 wt.-% polyoxyethylene sorbitan monolaurate und an indicator mixture selected from methyl red sodium salt, bromocresol green, phenolphthalein, 1-naphthole benzein and methylene blue, 0.01 to 0.2 wt.-% of a preserving agent, in particular sodium acide, the balance being water.

7. A solvent or solvent mixture according to claim 3, wherein a protective protein, in particular bovine serum albumin, is added to the solvent or solvent mixture.

8. A decomposing solution for use in a method according to claim 1, wherein the decomposing solution, for at least 80 wt.-%, is comprised of polar organic solvents selected from ketones including 3 to 8 carbon atoms, monovalent alcohols including 1 to 5 carbon atoms, organic acetates such as methyl, ethyl and propyl acetate as well as a non-ionic detergent, in particular polyoxyethylene sorbitan monolaurate.

9. A decomposing solution according to claim 8, wherein the decomposing solution contains 2 to 8 wt.-% methyl ethyl ketone, 2 to 8 wt.-% n-butanol, 2 to 8 wt.-% ethyl acetate, 70 to 90 wt.-% acetone as well as 0.01 to 0.5 wt.-% non-ionic detergent.

10. A device for carrying out the method according to claim 1, which comprises at least one container containing the solvent or solvent mixture according to claim 3 and the decomposing solution according to claim 8 as well as at least one container containing test strips known per se for the detection of different drugs or drug substitutes.
